(19) United States
(12) Patent Application Publication
(10) Pub. No.: US 2012/0277994 A1
(43) Pub. Date: Nov. 1, 2012

(54) SYSTEM AND METHOD FOR PROVIDING EVENT-BASED SERVICES

(75) Inventor: Curtis Broome, Oakland, CA (US)

(73) Assignee: EventMobile, Inc., Oakland, CA (US)

(21) Appl. No.: 13/544,808

(22) Filed: Jul. 9, 2012

Related U.S. Application Data
(63) Continuation of application No. 12/125,487, filed on May 22, 2008, now abandoned.
(60) Provisional application No. 60/940,347, filed on May 25, 2007.

(51) Int. Cl. G06Q 30/02; G01C 21/00

(52) U.S. Cl. 701/537; 705/14.5

(57) ABSTRACT

A system and method for providing event-based services are disclosed. According to one embodiment of the present invention, merchants and users subscribe with an Event Service Provider (ESP), which includes a server and database. The database maintains information relating to merchant events and subscriber's event preferences. Based on time-sensitive merchant event information, an event is published. Furthermore, the database is queried to determine the preferred subscribers based upon the subscriber's event preferences and the merchant event information relating to the published event. Lastly, an event communication is delivered to the device associated with the preferred subscriber.

### CROSS-REFERENCE TO RELATED APPLICATIONS

This application is a continuation of U.S. patent application Ser. No. 12/125,487 filed May 22, 2008 which claims the benefit of and is a non-provisional of U.S. patent application Ser. No. 60/940,347 filed on May 25, 2007, entitled entitled “SYSTEM AND METHOD FOR PROVIDING EVENT-BASED SERVICES,” which is hereby incorporated by reference, as if set forth in full in this document, for all purposes.

### FIELD OF THE INVENTION

The present invention relates generally to the field of information distribution and more particularly to a system and method for collecting and distributing event-based information among merchants and users.

### BACKGROUND OF THE INVENTION

With the use of the Internet becoming commonplace, there is now an overwhelming demand for the most current news and information. The latest headlines, weather, and traffic reports are just a few of the many types of information that online users demand. In addition, merchants are able to utilize the Internet to post new sales and promotional events. However, merchants are only able to reach customers when they visit the merchant's website, receive emails, or by paying for expensive advertisements on more popular websites, more popular mobile websites or applications, or more popular mobile internet devices.

Wireless devices, particularly cellular phones, have become ubiquitous in today's society and provide yet another platform for people to obtain live information. Today's wireless devices can access the Internet at a touch of a button, providing users with instantaneous access to any desired information, including downloadable content such as streaming video and audio files. However, users are typically able to receive this desired information and content by performing a search through a search engine, or by visiting a desired website already known to the user. Moreover, merchants are still limited in how they can communicate with a target consumer in order to deliver the latest sales and promotional news.

Therefore, there is a need to provide merchants and users alike with a system and method for accessing, publishing, and sharing news, multimedia content, and the like without requiring a user query for the desired information.

### BRIEF SUMMARY OF THE INVENTION

Embodiments of the present invention provide a system and method for providing event-based services in a web-based communication environment.

In an exemplary embodiment, the method for providing event-based services includes storing, within a database, event information relating to a merchant, ticket provider, performing artist, merchant aggregators, or the like, and storing subscriber information relating to a user. Based on an event time contained in the event information, an event record is published and the database is queried to determine preferred subscribers. The preferred subscribers can be determined based upon the subscriber event preferences and the event information relating to the published event record. An event communication can be sent to any and all preferred subscribers.

Another exemplary embodiment relates to a system for providing event-based services. The system includes merchant computer systems (or devices), subscriber computer systems (or devices), and an event service provider (“ESP”) system. A communication network is provided, which interfaces merchants systems, subscriber devices and the ESP system. The ESP system includes a server and database for storing information relating to the merchants and subscribers. The Event Service Provider publishes a record of the merchant event and determines the preferred subscribers based upon the subscriber's event preference and the merchant's event information. An event communication is then relayed to the subscriber device of each preferred subscriber.

### BRIEF DESCRIPTION OF THE DRAWINGS

FIG. 1A is a block diagram illustrating aspects of an exemplary operating environment according to an embodiment of the present invention, and FIG. 1B is a simplified block diagram illustrating the same.

FIG. 2 is a flowchart illustrating the operation of the system of FIG. 1 according to an embodiment of the present invention.

FIGS. 3A and 3B are illustrative examples of a daily event record displayed on a web-based interface according to an embodiment of the present invention.

FIGS. 4A and 4B are illustrative examples of a weekly event record displayed on a web-based interface according to an embodiment of the present invention.

FIGS. 5A and 5B are illustrative examples of a monthly event record displayed on a web-based interface according to an embodiment of the present invention.

FIGS. 6A and 6B are illustrative examples of a 90 day event record displayed on a web-based interface according to an embodiment of the present invention.

FIGS. 7A and 7B are illustrative examples of an event window displayed on a web-based interface according to an embodiment of the present invention.

FIG. 8 is an illustrative example of an event communication displayed on a web-based interface according to an embodiment of the present invention.

FIGS. 9A and 9B are illustrative examples of an event search box displayed on a web-based interface according to an embodiment of the present invention.

FIG. 10 is a block diagram of the messaging and sharing feature according to embodiments of the present invention.

### DETAILED DESCRIPTION OF THE INVENTION

A system and method for providing event-based services is disclosed. The following description is provided to enable any person skilled in the art to make and use the invention and sets forth the best modes contemplated by the inventor for carrying out the invention. Various modifications will remain readily apparent to those skilled in the art. Any and all such modifications, equivalents and alternatives are intended to fall within the spirit and scope of the present invention.

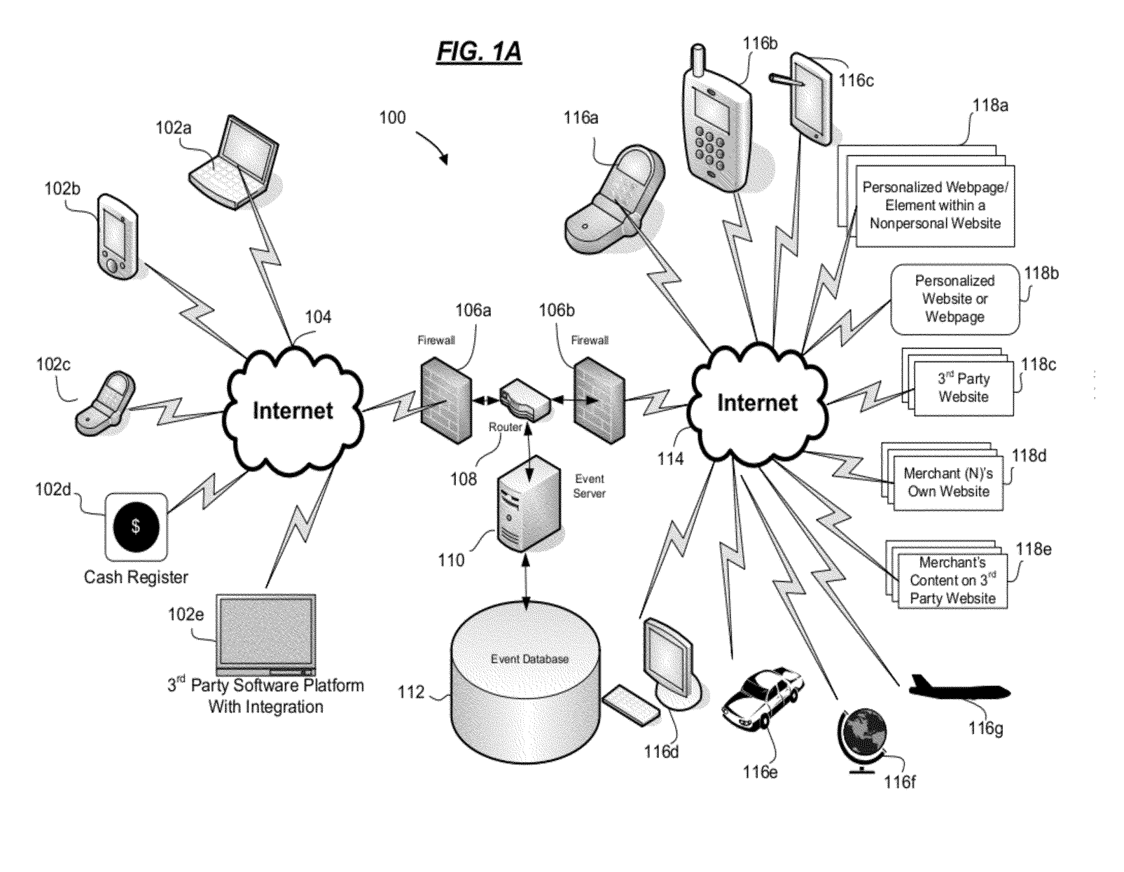

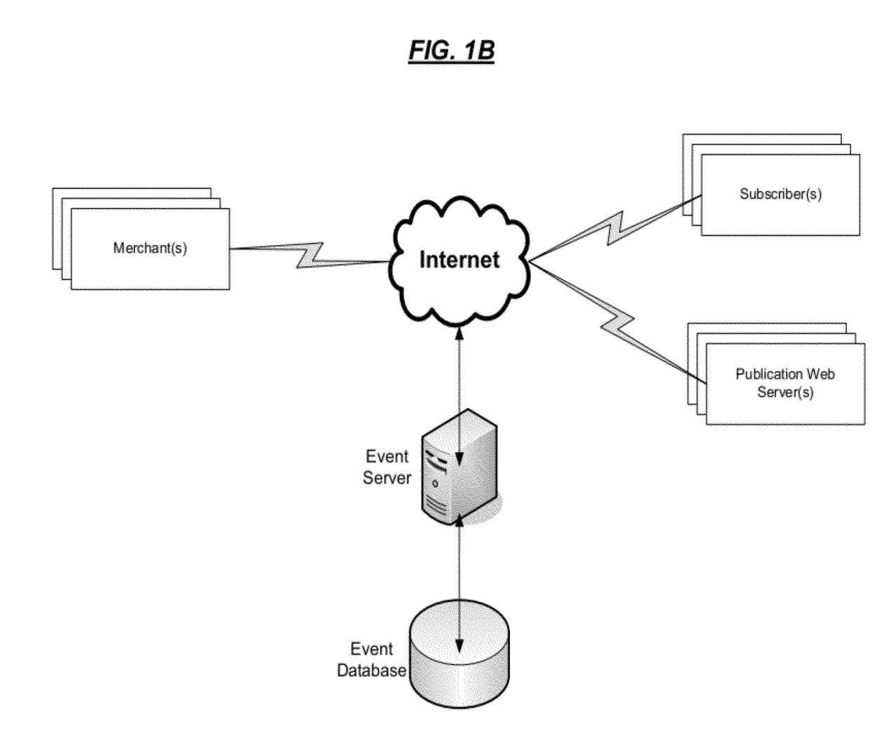

FIG. 1A provides an overall view of the preferred communication system, and FIG. 1B is a simplified view according to embodiments of the present invention. As shown in FIG. 1A, communication system 100 includes a plurality of merchant systems/devices (“merchants”) 102a, 102b, 102c, 102d, and 102e, an event server 110, an event database 112, a plurality of subscriber systems/devices (“subscribers”) 116a, 116b, 116c, 116d, 116e, 116f, and 116g and a plurality of website and web pages 118a, 118b, 118c, 118d, and 118e.

An Event Service Provider (“ESP”) runs on the event server 110, which is connected to network 104 and 114. Firewalls 106a and 106b, and router 108 may be utilized for additional security for the event server 110. An event database 112 is associated with event server 110 and is responsible for storing information relating to the merchants, ticket providers, performing artists, merchant aggregators, and subscribers. For example, the event database 112 stores a merchant profile of each merchant who registers with the ESP. A more detailed description of the merchant profile is provided below. The ESP supplies a web interface for interactions among the merchants and subscribers. Embodiments of the present invention are usable with a number of networks, such as the global internetwork of networks referred to as the “Internet” and its variants (e.g., intranets, virtual nets, overlay networks and the like).

The merchants 102a, 102b, 102c, 102d, and 102e may be any vendor offering goods and services across the Internet or other networks including ticket providers, performing artists, and merchant aggregators. Additionally, merchants 102a, 102b, 102c, 102d, and 102e may also be any entity interested in providing information to a user, such as a ticket or real estate broker, individuals, or school administrators. Merchants register with the ESP by filling out a merchant profile via the ESP web interface. The merchant profile includes detailed information about the merchant such as name, contact information, and address. Furthermore, merchants 102a, 102b, 102c, 102d, and 102e then send to the event server 110 through network 104, and the ESP web interface, the merchant profile and event information relating to an upcoming event. The event information may include the time, date, or location of the event, venue, category and/or publication duration.

Subscribers subscribe with the ESP via the network 114 and the ESP web interface. A subscriber can be any electronic device configured to connect to the network. For example, subscriber 116a is a mobile phone device with a third party client, subscriber 116b is a personal cell phone or smart phone with a native client, and subscriber 116c is a personalized wireless device with a native or third party client, subscriber 116d is a personal computer, subscriber 116e is a computer or subscriber device on board an automobile, subscriber 116f is a global positioning system or mapping service, and subscriber 116g is a computer or subscriber device on board an aircraft. Additionally, the subscriber device may be equipped with a global positioning system (GPS) receiver for relaying positional information to the event server.

The event server 110 saves information related to each subscriber in the event database 112. For example, subscriber information may include an Internet client ID, a wireless device ID, and event preferences. In addition, a subscriber might specify a number of event preferences for various entertainment, lifestyle, and business categories. For example, event preferences may include desired music artists, sports teams, restaurants, and the like. The event preferences associated with each subscriber are important in determining which event-based service each particular subscriber would like receive.

Additionally, merchants and users can use the ESP to share event information from a wide range of devices with internet access to a wide range of other devices with internet access. For example, event sharing can be accomplished using internet access devices (IAD), internet access services (IAS) such as mapping or music services, or via internet accessing vehicles (transportation services) such as automobiles, trucks, sport utility vehicles, or airplanes. Event information sharing offers a number of different scenarios including merchant to user, merchant to a targeted group, merchant to preferential or untargeted group, user to user, user to familiar group, user to unknown user, or user to known group (public sharing). The ESP web interface is also configured to allow users to maintain a personalized address book of users for quick reference. However, the spirit and intent of event information sharing can be maintained through other scenarios, formats, device, or services not listed here.

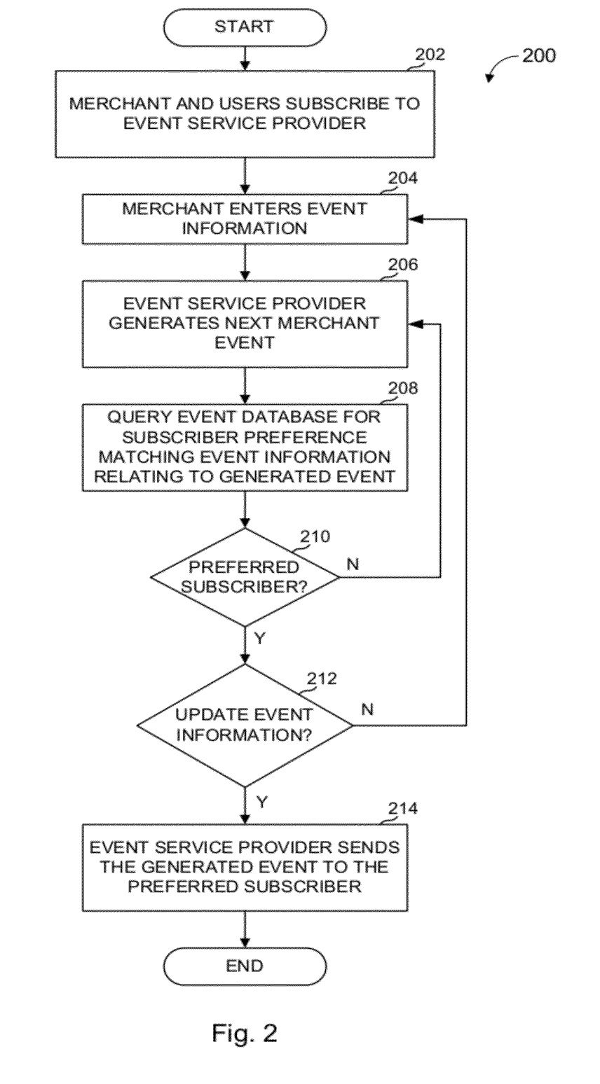

Referring now to FIG. 2, a flow diagram illustrating the preferred steps in accordance with one embodiment of the present invention is shown. In step 202, merchants and users subscribe with the ESP through the ESP web interface. Typically, the subscription entails filling out an online form and agreeing to the terms specified by the Event Service Provider. Specifically, the users input contact information and the types of event information that they prefer to receive. For example, a subscriber may only wish to receive messages concerning live music events in Northern California. Subscribers can limit their preferences even further based on the city, category, venue, or their current GPS position. Following step 202, in step 204, merchants load event information concerning a specific event. In particular, merchants may input time-sensitive promotional messages concerning a particular event. For example, a merchant may input the location, category, date, and time of a particular event. Merchants may also input a predetermined time duration in which the event is published for subscribers to view. For example, a merchant, or ticket broker, may only wish to sell or advertise reduced tickets during a three hour time period prior to start of a concert.

In step 206, the ESP publishes a record of the merchant event based upon the event time, date, and location information entered by the merchant. Publication of an event record enables subscribers to view a detailed description of the event through the ESP web interface and an event window. The event window shows a detailed listing of an individual event record and contains all the corresponding event information including price, contact phone numbers, images, and other event content. In addition, publication of the event record may simultaneously occur on the merchants own website, a third party website, and/or a personalized webpage or website. Furthermore, once the predetermined publication duration expires, the event record is removed from the ESP web interface and is no longer available for subscribers to view. This configuration provides for a number of advantages over the prevailing methods.

For instance, merchants are able to update event information as necessary, thereby instantaneously republishing the updated event information for subscribers to view. For example, if the date for a concert is approaching, and a large number of tickets remain unsold, the merchant may then republish the event information and sell the remaining tickets at a reduced rate. Additionally, a merchant can remove an event record from the ESP in the case that the event sells out, the event is canceled, the event changes, or there are changes in the merchant status. Moreover, since the published event is time-sensitive, merchants may enter event information for all scheduled events, and these events will be published immediately and appropriately based upon the date, time, and location of the event. These features allow the event database to be dynamically and continually managed, and allow merchants more flexibility in broadcasting time-sensitive event information.

In step 208, the ESP then retrieves from the event database, the event information related to the published event record. The ESP queries the event database to retrieve all preferred subscribers who have event preferences which match the event information of the published event record. For example, a subscriber may set “The Rolling Stones” as a preferred music artist, and “Northern California” as a preferred geographical location under the subscriber's event preferences. Therefore, if the Rolling Stones were to schedule a concert at a venue (merchant) located in Northern California, then the event server would determine this subscriber as a preferred subscriber based upon the subscriber's event preferences and the merchant's event information.

In step 210, for each preferred subscriber, the ESP retrieves the user device information related thereto, and in step 214, sends an event communication to the user devices of all the preferred subscribers. The event communication may include a short description of the event such as artist, location and time. The preferred subscriber may then access details of the published event through the event communication. For example, the event communication may be a text-based message containing a hypertext link to the ESP web interface. It should be understood that “text-based” messages are not limited to a text messaging system, such as SMS, but includes dynamic text-based messaging (dtext) that are not constrained by SMS text limits. According to embodiments of the present invention, dtext can be an embedded feature of the ESP interface, thereby allowing subscribers to message directly to one or more other subscribers. Lastly, if no preferred subscribers are discovered, then in step 212, the merchant may update the event information and the ESP provider will republish the event record based upon the updated event information.

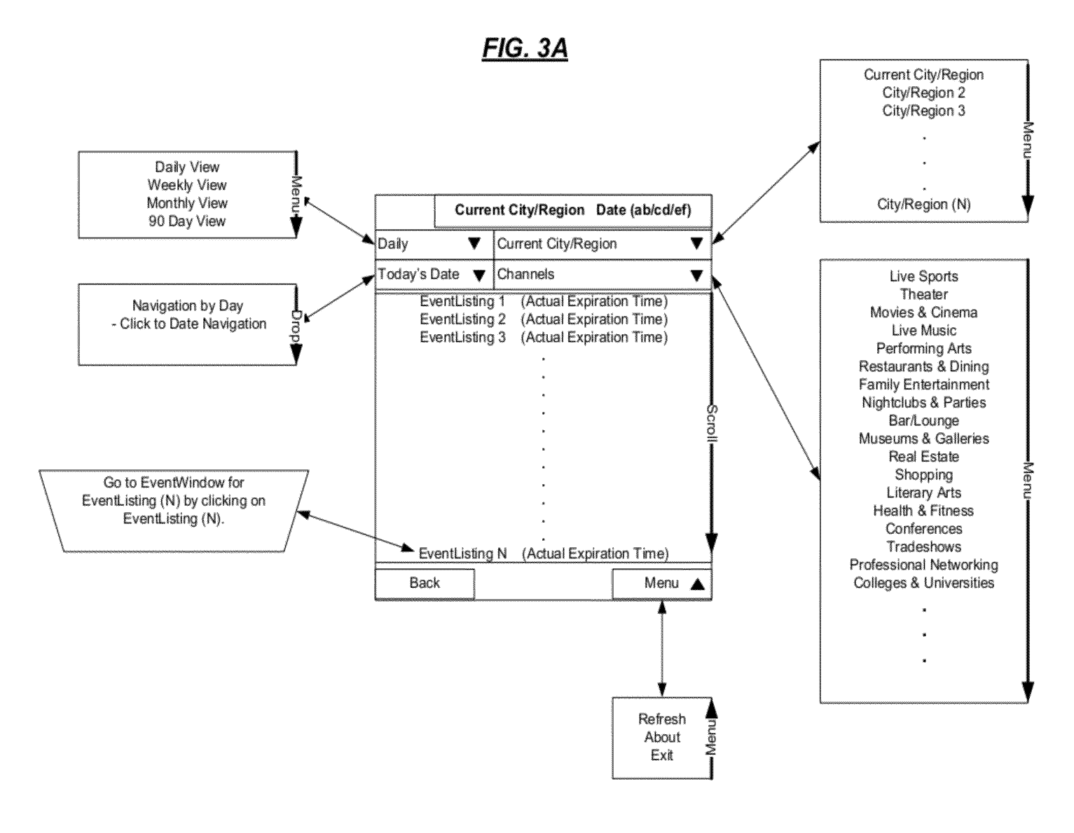

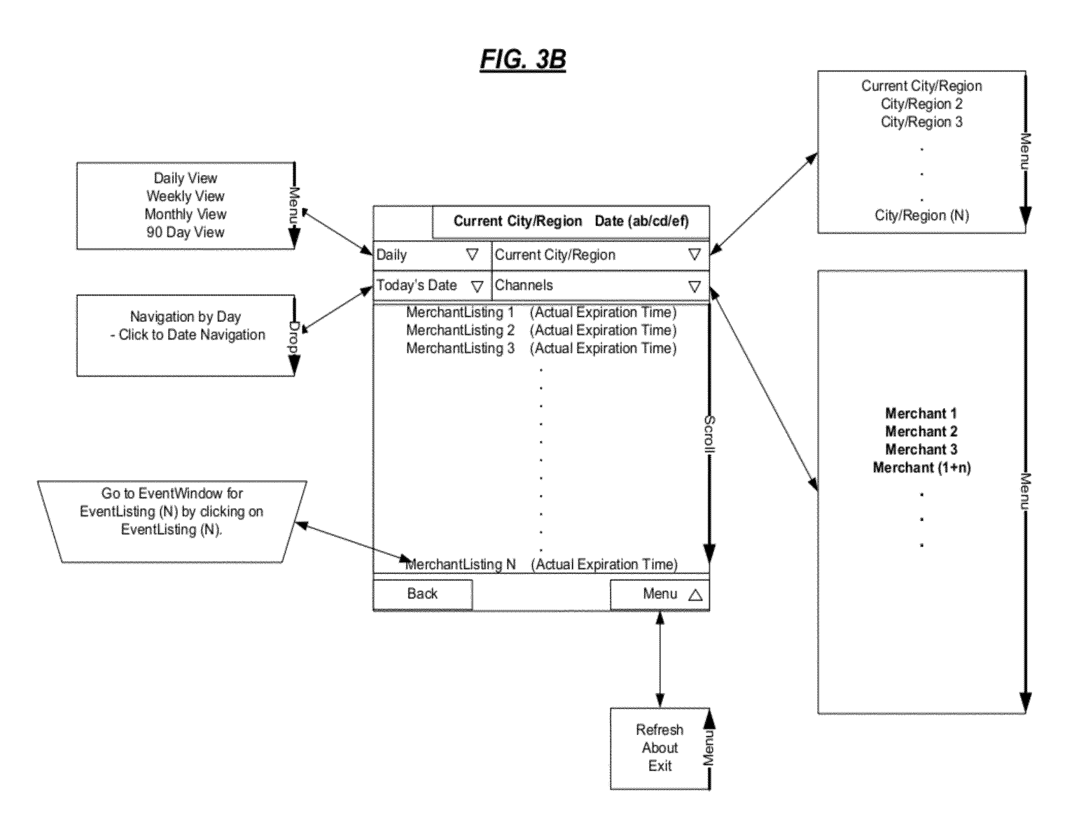

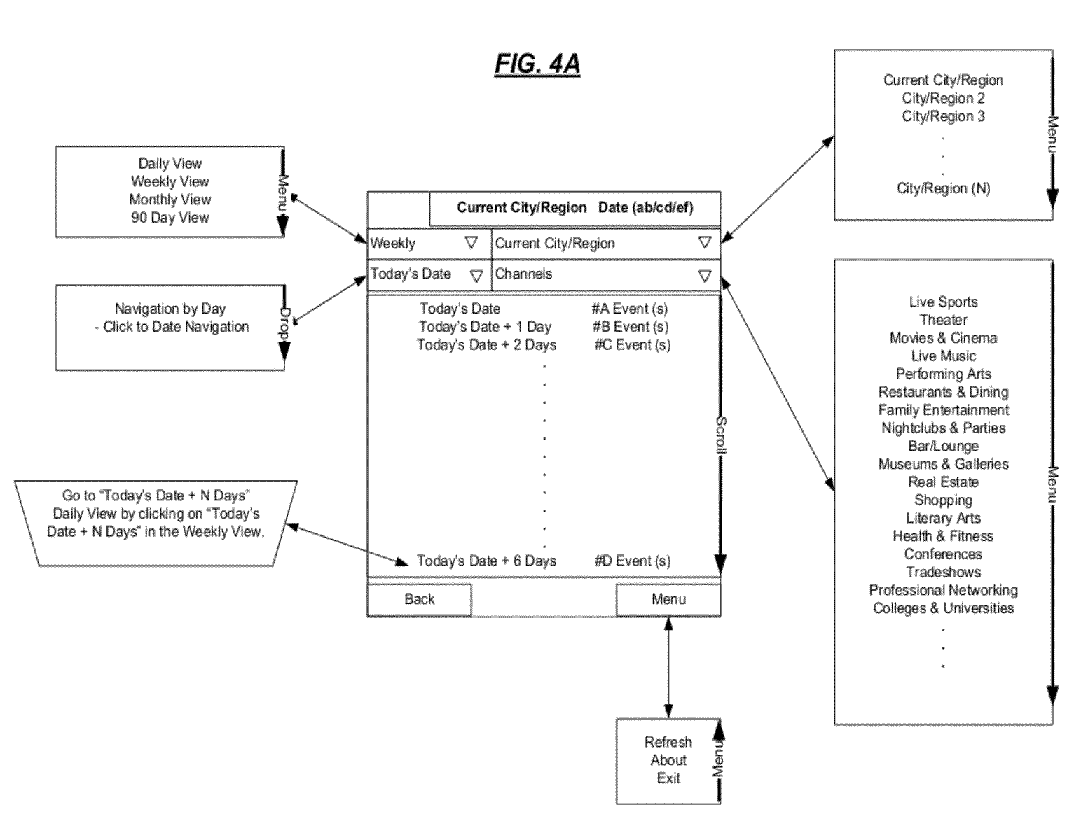

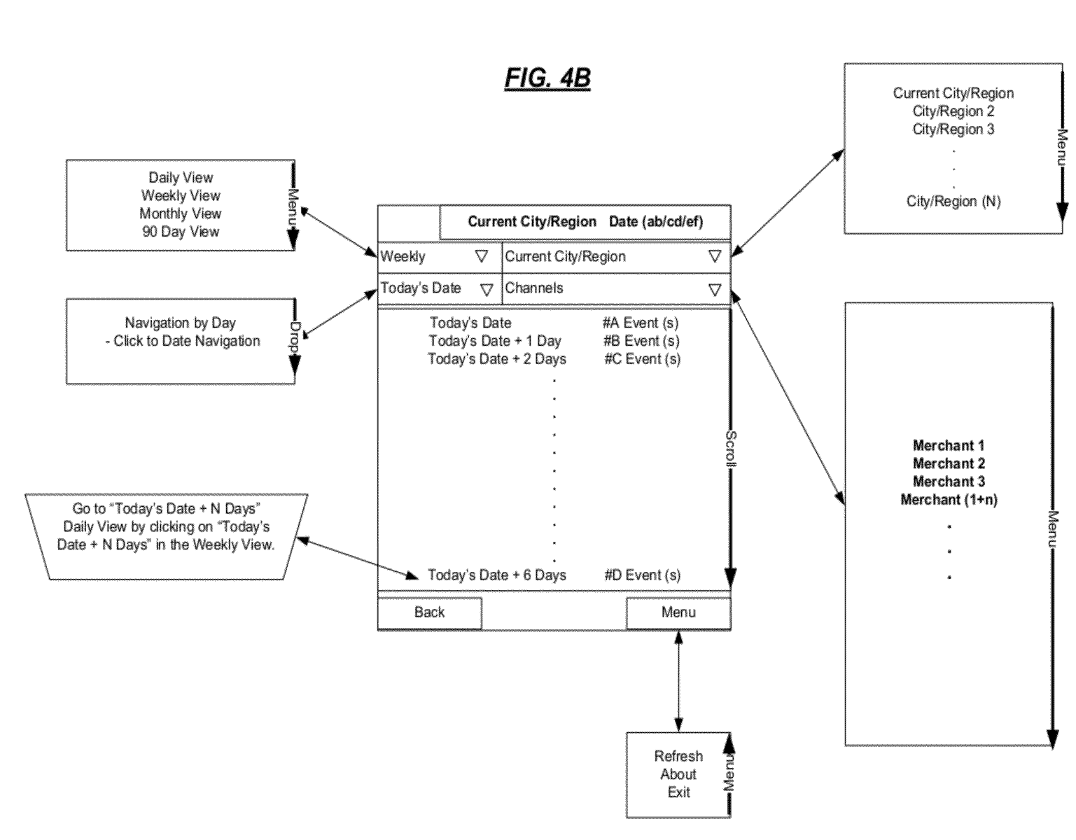

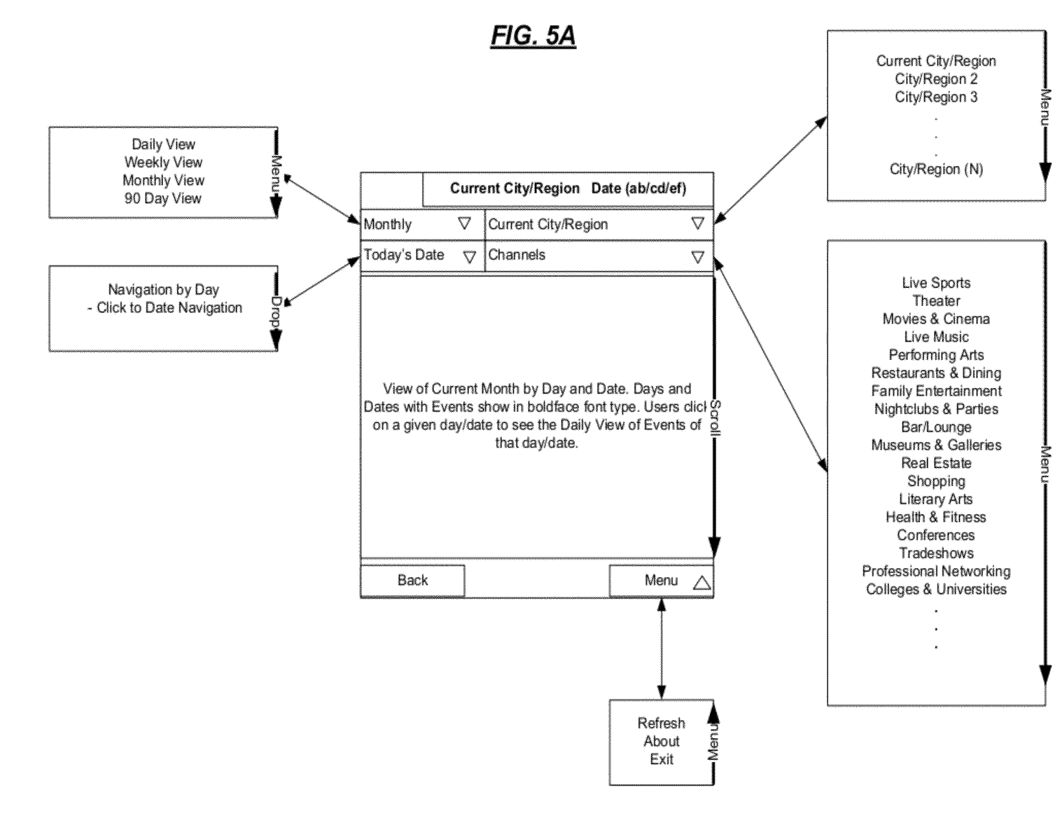

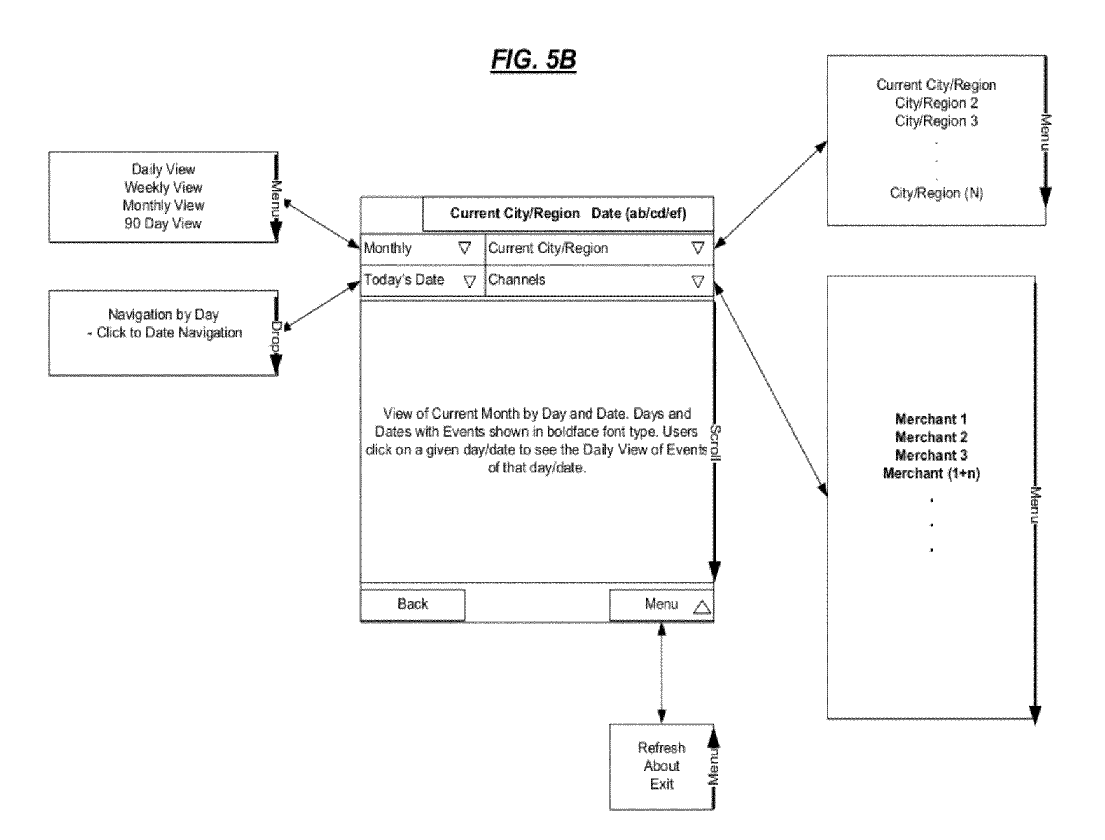

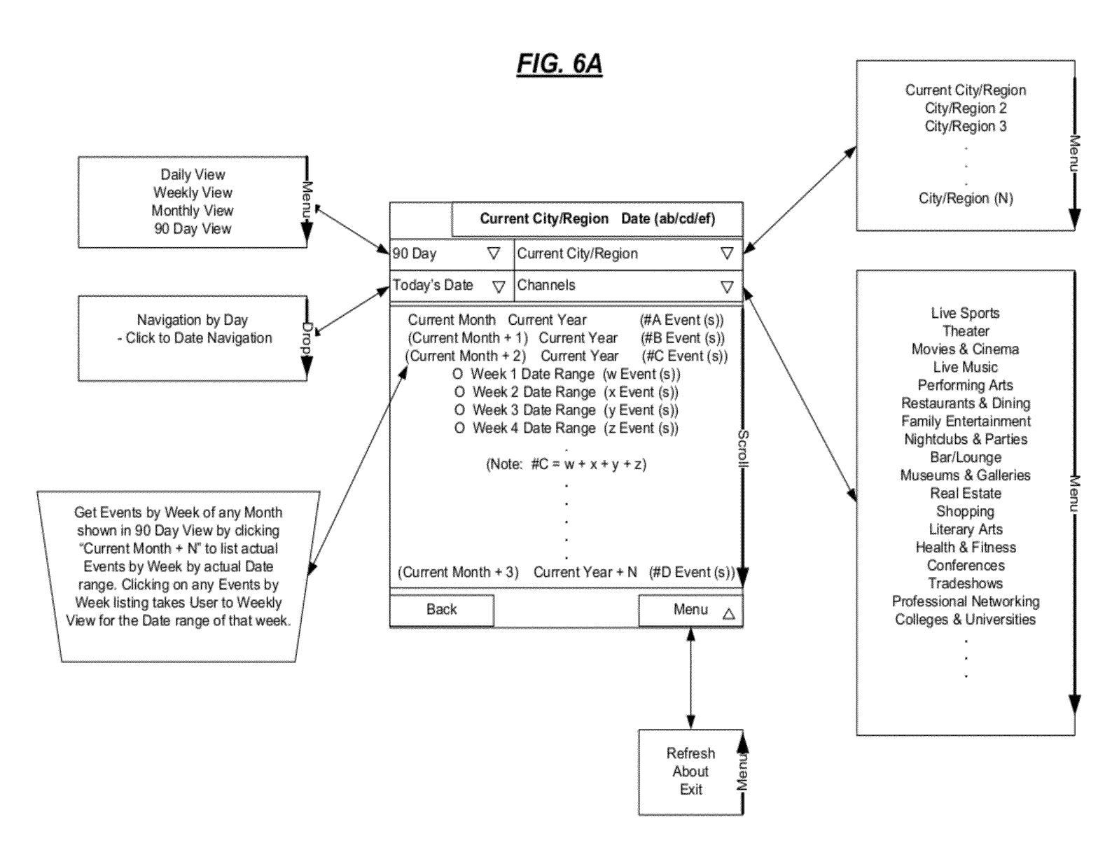

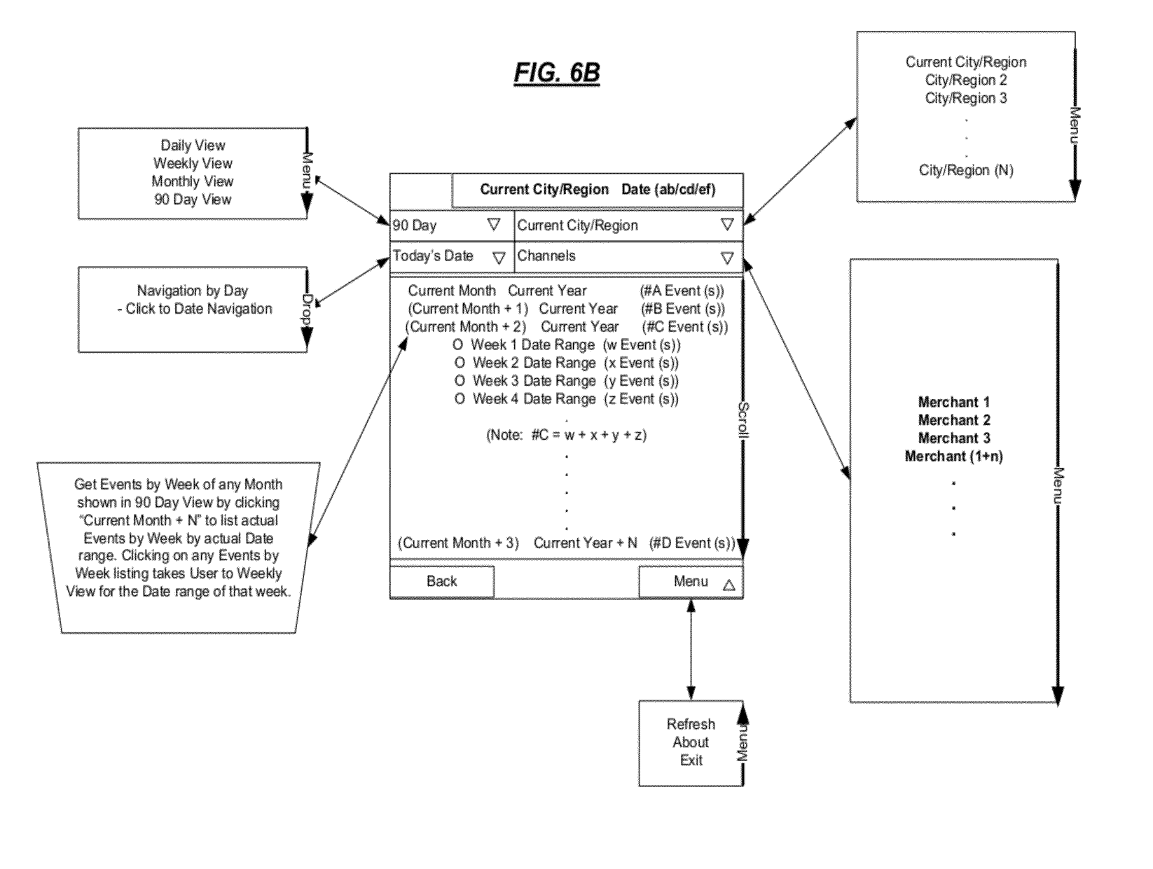

FIGS. 3-6 are illustrative examples of a listing of event records shown by the ESP web interface. FIG. 3A is a daily view of a preferential aggregate listing of events offered by merchants for a given date, time, and location (Event Listing). FIG. 3B is a daily view of events offered by a specific, preferred merchant only for a given, date, time, and location (Merchant Listing). FIGS. 4A, 4B, 5A, 5B, 6A and 6B are weekly, monthly, and ninety-day views of an Event Listing and Merchant Listing, respectively.

Merchant Listing is always a subset of the Event Listing, although a Merchant

Listing may include multiple event types, venues, ticket types, and more based on time, date, location, etc. For example, a music event and venue management company operating music events in Fillmore and Warfield theatre in San Francisco, could register to become a merchant of the ESP. The company's Merchant Listing in San Francisco would be for all events including the Fillmore and the Warfield Theater, or either the Fillmore or Warfield Theater, or both scenarios. By contrast, the San Francisco Event Listings would feature all event services offered in San Francisco, including the Fillmore and Warfield Theater, as well as any other merchant venue, performing artist, ticketing service, or other merchant type offering event services in San Francisco during times which coincide with the Merchant Listing offerings of the company.

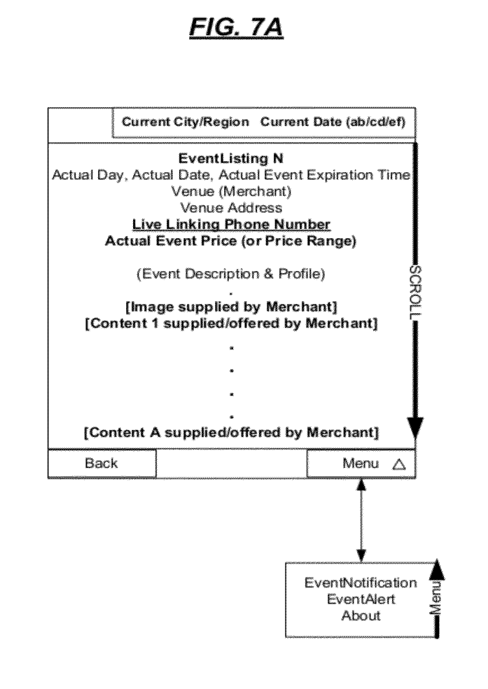

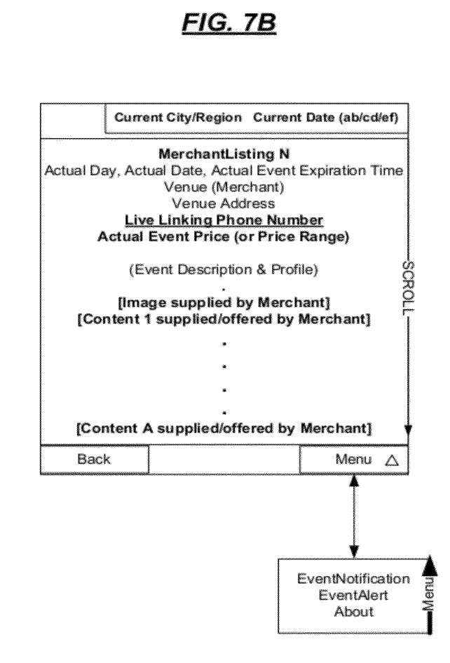

FIG. 7A is an illustrative example of the event window provided by the ESP web interface, which displays a detailed description of an event record such as merchant name, venue address, date/time, expiration date, etc. In addition, the event window may display other event content such as driving directions, images, movies, music, or other multi-media content supplied by the merchant. The subscriber may access all this information by activating the corresponding links in the event window. In addition, the event window can be utilized to facilitate many types of ecommerce transactions including ticket, merchandise, or music purchase, or to make a reservation. FIG. 7B shows the event window that a user would access while viewing a specific event on the Merchant Listing. The event window may or may not show the same event information when viewed by a user. For example, the information may vary depending on whether event channels or merchant channels are utilized. Alternatively, the event window can be displayed as text only, text with picture(s), text with audio, text with video, video based, audio based, or any combination thereof

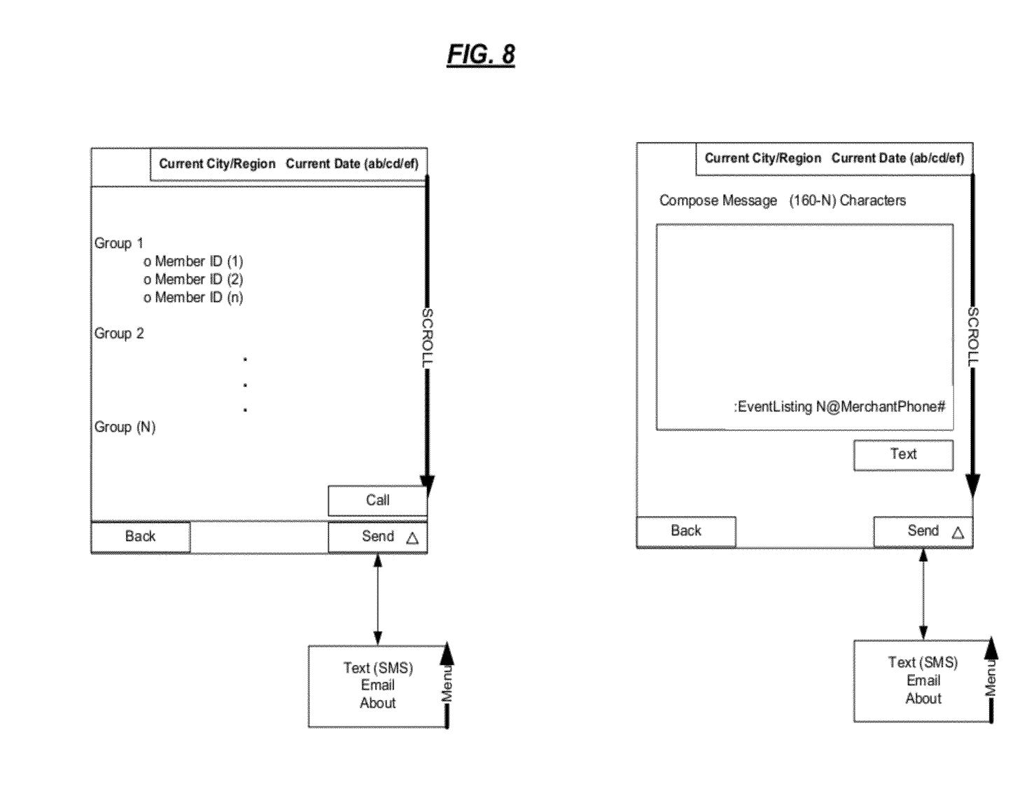

FIG. 8 is an illustrative example of a user interface usable for user sharing and messaging communications according to aspects of the present invention. Merchants may also directly message an individual or group of subscribers. These messages may be communicated to a subscriber by text message via a short messaging system (SMS), dtext, instant messaging, email address including video, audio, or picture mail, voice over IP, or any other network communication service. In addition, via the ESP web interface, users can communicate with other users, non-users, groups of users, or a group of non-users.

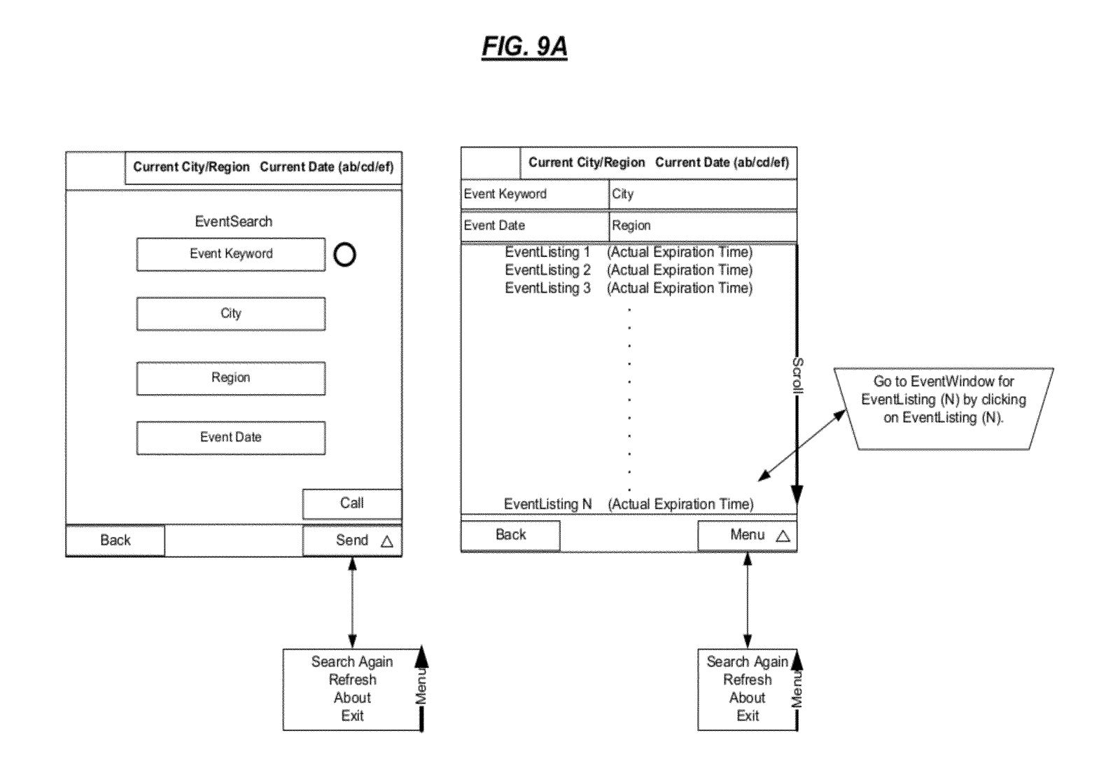

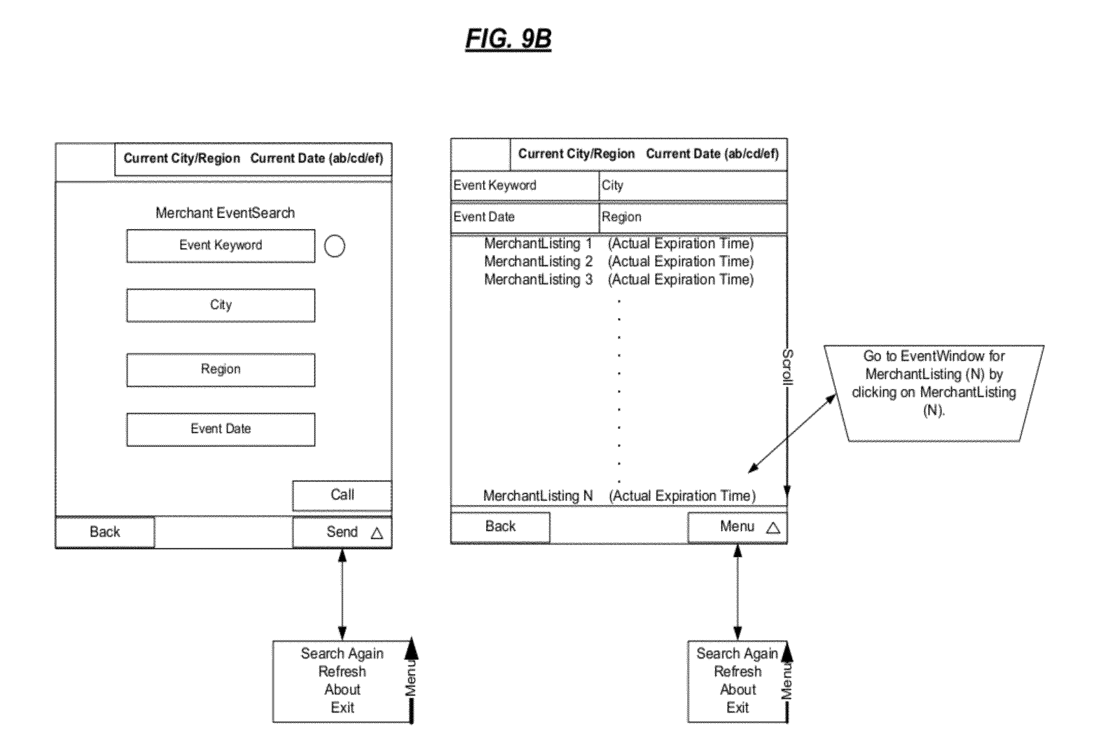

Alternatively, a subscriber may perform a search for a particular event through a search window provided by the ESP web interface. FIGS. 9A and 9B are illustrative examples of an event search window. As shown in FIG. 9A, a subscriber may search for a particular event by keyword, event date, zip code, and/or event location. The event database is then queried for all events matching the specified user query. Further, the results are displayed to the subscriber, via the ESP web interface, as a record of matching events. The subscriber may then select a particular event by clicking on the record of the event, in which case the event window associated with the selected event will be displayed to user. FIG. 9B shows a merchant event search, in which users can search a specific merchant for event information by keyword, time, date, location, ticket availability, etc.

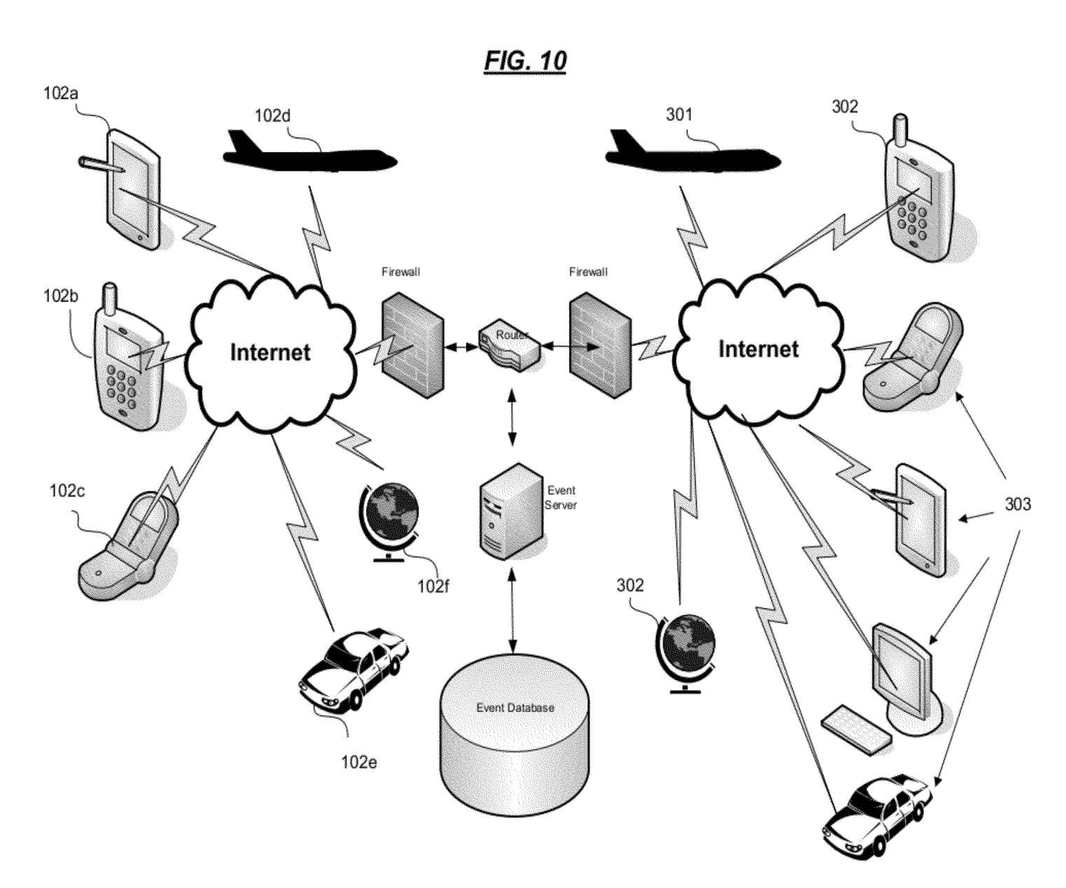

FIG. 10 is a block diagram illustrating another feature afforded by embodiments of the present invention. In addition to the relaying of merchant event information to other subscribers, subscribers 102a, 102b, 102c, 102d, 102e, and 102f may use the ESP web interface to message another user 301, non-subscriber 302, or group of users/non-subscribers 303 by email, text-based message including dynamic texting and instant messaging, video mail, audio mail, picture mail, voice over IP, or any other network communication service. Therefore, subscribers may message users without the character and other functional limitations of cell phone and other service providers.

Embodiments of the present invention can provide a number of advantages over conventional methods. In particular, merchants are empowered with the ability to quickly publish time-sensitive promotional messages, thereby creating instantaneous awareness and demand for a particular good or service. Moreover, since the event information is sent directly to all the interested parties, users are no longer forced to query random databases for information concerning a desired good or service. Further, the published promotional event is time-sensitive and automatically removed from publication upon the expiration of a predetermined time. In addition, communication and publishing can be accomplished in real-time for instantaneous updating of event information.

In addition, merchants are able to capture new business leads through direct and organic lead capture. Direct lead capture may occur when a registered user, or subscriber, consumes an event received preferentially in the Event Listings. Organic lead capture may occur when a registered user/subscriber shares event information that is consumed by another registered user/subscriber, or that is consumed by a non-registered user. Accordingly, embodiments of the present invention offer several different opportunities for merchants to gather a substantial number of new clientele.

It will be recognized by persons of ordinary skill in the art that the method of the invention has many applications, and that this description has not attempted to enumerate all possible variations. For example, functionality exists such that users can receive and share live broadcast or simulcasts including video, audio, text, or any combination thereof, and merchants can also broadcast live events based on time, date, and location. In addition, users may also submit event information, enabling them to share and invite other users to their own event. The ESP web interface also includes functionality to allow users to input, share, and publish reviews of a given event, or any experiential aspect of the event (i.e. venue, food, service, etc.). The scope and spirit of the invention also extends to various combinations and modifications that may fall within the spirit of the appended claims.

What is claimed is:

1. In a web-based communication system that includes an event server, a database associated with the event server, at least one merchant system used by a merchant, and a plurality of subscriber devices used by a subscriber, a method for providing event-based services comprising:
storing in the database, for each merchant, merchant information including a merchant profile and event information, wherein in the event information includes an event time;
storing in the database, for each subscriber, subscriber information including a subscriber profile and event preferences;
determining, by the event server, which of the subscribers are preferred subscribers with respect to an event that is an event published based on its event time, wherein the preferred subscribers are determined based upon a match between the stored event preferences for the subscriber and the event information relating to the published event; and
sending, using the event server, an event communication to the preferred subscribers relating to the published event.

2. The method of claim 1, wherein the event information includes a publication duration, and
wherein the event is published for a length of time corresponding to a time set in the publication duration, or until canceled by the merchant.

3. The method of claim 1, wherein the subscriber device is any electronic device, system, service, or vehicle with network connectivity.

4. The method of claim 1, wherein the merchant is any vendor offering goods or services, a performing artist, a ticket provider, a merchant aggregator, or a user.

5. The method of claim 1 wherein the event information includes the name, location, cost, and time of the event.

6. The method of claim 5, wherein the preferred subscribers are determined based upon the location, date, time, or user preferences of the event.

7. The method of claim 1, wherein the subscriber receives the event communication and accesses the event information relating to the published event.

8. The method of claim 1, wherein users can use a graphical user interface to search for either all merchants, or a specific merchant based on date, time, and location.

9. The method of claim 1, wherein the event communication includes a text message, email, video message, audio message, or any other form of multimedia content.

10. The method of claim 1, wherein the merchant sends event information directly to a user.

11. A system for event-based communication comprising:
at least one merchant system used by a merchant and merchant information, wherein the merchant information includes a merchant profile, event information and an event time;
at least one subscriber device used by a user and subscriber information, wherein the subscriber information includes a subscriber profile and event preferences;
a database configured to store the merchant information and the subscriber information, and publish an event based upon the event time; and
a communication system and graphical user interface for facilitating communication between the merchant system, subscriber device, and database,
wherein upon publishing the event, the server determines one or more preferred subscribers and sends an event communication to the preferred subscribers.

12. The system of claim 11, wherein the event information includes a publication duration; and
wherein the event is published for a length of time corresponding to a time set in the publication duration, or until canceled by the merchant.

13. The system of claim 11, wherein the subscriber device is any electronic device, service, or vehicle with network connectivity.

14. The system of claim 11, wherein the merchant is any vendor offering goods or services, a performing artist, a ticket provider, a merchant aggregator, or a user.

15. The system of claim 11, wherein the event information includes the name, location, cost, and time of the event.

16. The system of claim 15, wherein the preferred subscribers are determined based upon the location, date, time or user preferences of the event.

17. The system of claim 11, wherein the subscriber receives the event communication and accesses the event information relating to the published event record.

18. The system of claim 11, wherein the communication system and graphical user interface configured to show wither an aggregate listing of events based on time, date, or location, or a listing of a singular merchant by date, time, or location.

19. The system of claim 11, wherein communication system and the graphical user interface includes a global positioning service, or mapping service to help navigate a user to the location of the event.

20. The system of claim 11, wherein the communication system and graphical user interface is configured to allow merchants and users to share event information with other merchants or users via any internet access device, internet access service, or vehicle having internet access.

21. The system of claim 11, wherein the communication system and graphical user interface is configured to allow a user to save an event record to a personalized listing.

22. The system of claim 11, wherein the system is configured to allow the merchant to message a user directly via text messaging, dynamic texting, instant messaging, audio messaging, video messaging, or email.

23. The system of claim 11, wherein the communication system is configured to allow merchants to broadcast live events to the subscribers.

24. The system of claim 11, wherein the communication system is configured to allow a user to submit and publish event information and invite other users.

25. The system of claim 11, wherein the communication system and graphical user interface is configured to allow a user to input, share, and publish reviews corresponding to aspects of the event.
